(19) United States
(12) Patent Application Publication
(10) Pub. No.: US 2008/0048371 A1
(43) Pub. Date: Feb. 28, 2008

(54) INDEXING ATTACHMENT MECHANISM FOR TORSION BARS

(75) Inventors: John K. Dagg, Shelby Township, MI (US); Mansour F. Asmar, Sterling Heights, MI (US); Tiage J. Carey, Oak Park, MI (US); Barton W. Mc Laughlin, Clawson, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/466,803

(22) Filed: Aug. 24, 2006

(51) Int. Cl. F16F 1/14

(52) U.S. Cl. 267/273; 267/277

(57) ABSTRACT

A torsion bar attachment mechanism for indexingly attaching a torsion bar to a cross-member component of a frame of a motor vehicle so that a range of torsion bars may be attached to a single adjuster arm. An adjuster arm has a barrel receptacle for indexingly receiving therein an adjuster barrel. The adjuster barrel has at least one barrel tab upstanding at its outer surface, and the surface of the barrel receptacle has a plurality of receptacle notches formed therein each of which being configured for receiving the barrel tab. When the adjuster barrel is received into the barrel receptacle of the adjuster arm, the barrel tab is indexingly disposed into one position of a predetermined plurality of positions of the barrel receptacle, wherein each position is defined by a receptacle notch and corresponds to a particular torsion bar, of a selected range of torsion bars to be used respectively therewith.

### TECHNICAL FIELD

The present invention relates to torsion bars used typically in automotive suspension systems, and more particularly to the attachment interface for providing a custom angular orientation of the torsion bar with respect to a cross-member of the vehicle frame. Still more particularly, the present invention relates to an indexing attachment mechanism for providing a plurality of customized torsion bar connection angles applicable to a plurality of torsion bars.

### BACKGROUND OF THE INVENTION

Referring to FIGS. 1A and 1B, a prior art torsion bar attachment interface 10 will be described.

A torsion bar 12, in the form of an elongated rod, is attached at one end to a wheel moving suspension member, as for example a control arm, and at the other end 12a is attached to a cross-member 14, as is shown at FIG. 1A. In order that movement of the wheel moving suspension member be springably related to the frame of the motor vehicle, the attachment of the end 12a of the torsion bar 12 to the cross-member 14 must be fixed and non-rotating with respect to the cross-member. Thus, as the wheel moving suspension member moves with movement of the wheel, the torsion bar undergoes twisting, which supplies resilient reaction in opposition to the wheel movement, based upon a selected torsion modulus of the torsion bar 12.

The prior art torsion bar attachment interface 10 is shown most clearly at FIG. 1B, considered in combination with FIG. 1A. The end 12a of the torsion bar 12 has a polygonal-faced torsion bar head 16, a hexagon being shown at FIG. 1B. The torsion bar head 16 is received into a counterpart polygonal-faced head seat 18 (a hexagon being shown) of an adjuster arm 20.

The bar cross-member 12 is U-shaped having first and second sidewalls 14a, 14b normally disposed with respect to an integrally connected upper wall 14c. At least one sidewall of the cross-member 14 has an aperture 26 into which the torsion bar end 12a is received. The first and second sidewalls 14a, 14b each have a non-circular nut hole 28 into which the elongated adjuster nut 24 rests. The upper wall 14c of the cross-member 14 has an inner concave contour 14d concentrically disposed with respect to the aperture 26, which compliments a convex contour 20c of the adjuster arm 20 which is, itself, concentrically disposed with respect to the head seat 18. The adjuster arm 20 is located between the first and second sidewalls 14a, 14b, wherein the convex contour 20c of the adjuster arm 20 rotatably abuts the concave contour 14d of the upper wall 14c.

An adjuster mechanism 25 is utilized to effect an adjustment of the angle of the adjuster arm 20 relative to the cross-member 12. The adjuster arm 20 has an arm member 20a having an abutment land 20b. The abutment land 20b is adapted to abut the end of an adjuster bolt 22. The adjuster bolt 22 is threadably engaged with a laterally elongated adjuster nut 24.

There is a torsion bar and a torsion bar attachment interface as described above at each of the left and right end portions of the cross-member, one for each of the left and right wheels, respectively, of the motor vehicle.

In operation, the torsion bar head 16 is seated into the head seat 18 of the adjuster arm 20, wherein the adjuster arm is custom for each selected type of torsion bar 12. The torsion bar is then torsionally preloaded for the suspension system and particular torsion bar, and then adjusted to an appropriate torsional load by the adjuster mechanism 25, wherein the adjuster bolt 22 is selectively rotated so that it threads with respect to the adjuster nut 24 and thereby adjusts the angle of the adjuster arm 20 relative to the cross-member 12.

Most motor vehicles that use a torsion bar suspension system have a means for adjusting the height of the suspension system. Two major architectures that currently use a torsion bar suspension system are full size pickups and sport utilities (i.e., GMC Sierra and Yukon), and small trucks and derivatives (i.e., GMC Canyon, Hummer H3). The full size pickups and sport utilities have an adjuster arm that applies a compressive load upon an adjuster bolt. The small trucks have an adjuster arm that reacts against an adjuster nut, which applies a tensile load upon an adjuster bolt. The adjuster arm for both examples have an interface to a hexagonal end of a torsion bar. This interface is machined at a specific angular orientation for the attachment interface.

By way of example, General Motors Corporation presently uses seven torsion bar adjuster arms across its light and heavy duty torsion bar suspension systems. Each of these adjuster arms has a unique angular orientation for the hexagonal interface between the arm and the torsion bar head. Each adjuster arm has a unique colored paint marking for part identification.

While the above-described torsion bar attachment interface 10 works well, it has the problem that a particular adjuster arm is needed for each particular torsion bar. Therefore, what remains needed in the art is to somehow make the adjuster arm capable of interfacing with a plurality of different torsion bars.

### SUMMARY OF THE INVENTION

The present invention is a torsion bar attachment mechanism for indexingly attaching a torsion bar to a structure, for preferable example the frame of a motor vehicle, so that a range of torsion bars may be attached to a single adjuster arm.

The torsion bar indexing attachment mechanism according to the present invention includes an adjuster arm which has a barrel receptacle for indexingly receiving therein an adjuster barrel. The adjuster barrel has at least one barrel tab upstanding at its outer surface, and the surface of the barrel receptacle has a plurality of receptacle notches formed therein each of which being configured for receiving the barrel tab. When the adjuster barrel is received into the barrel receptacle of the adjuster arm, the barrel tab is indexingly disposed into one position of a predetermined plurality of positions of the barrel receptacle, wherein each position is defined by a receptacle notch and corresponds to a particular torsion bar, of a selected range of torsion bars, to be used respectively therewith. The adjuster barrel is provided with a polygonal faced head seat for receiving therein a complimentarily shaped torsion bar head of any of the torsion bars of the range of torsion bars to be used with respect to the corresponding plurality of receptacle notches.

The rotational loads applied upon the adjuster barrel by torsional loads on the torsion bar will cause the adjuster barrel to tend to rotate around the axis of the torsion bar. The barrel tab of the adjuster barrel reacts against the receptacle notch into which it is seated so as to thereby resist this tendency to rotate.

In one embodiment of the present invention, the adjuster arm has a convex contour concentrically disposed with respect to the barrel seat which abuts a complimenting concave contour of the inner surface of the upper wall of the cross-member. Alternatively, in a second embodiment of the present invention, each of the first and second sidewalls may be provided with a bushing upon which a respective arbor of the barrel rotatably rests. In both embodiments, an adjuster mechanism is used to adjust the angle of the adjuster arm relative to the cross-member so that the height of the suspension can be adjusted.

As an optional construction of the barrel, an axial slit may be provided, wherein torsional loads of the torsion bar will cause the barrel to expand and apply a pressure to the surface of the barrel receptacle.

While compressive loading of an adjuster bolt is preferred, operation is not limited to this type of loading, as the adjuster bolt may be oppositely mounted with respect to the adjuster arm so that it is engaged therewith in extension rather than compression.

Accordingly, it is an object of the present invention to provide a torsion bar attachment mechanism for indexingly attaching a torsion bar to a frame cross-member so that a range of torsion bars may be attached to a single adjuster arm.

This and additional objects, features and advantages of the present invention will become clearer from the following specification of a preferred embodiment.

### BRIEF DESCRIPTION OF THE DRAWINGS

FIGS. 1A and 1B are perspective views of a prior art torsion bar attachment interface with respect to a cross-member of a frame of a motor vehicle.

FIG. 2 is a perspective, exploded view of a first embodiment of the torsion bar indexing attachment mechanism according to the present invention.

FIG. 3 is a perspective, operational view of the torsion bar indexing attachment mechanism of FIG. 2, shown operatively interfaced at a first index.

FIG. 3A is a perspective, operational view of the torsion bar indexing attachment mechanism as in FIG. 3, shown operatively interfaced at a second index.

FIG. 4 is a perspective, operational view of the torsion bar indexing attachment mechanism of FIG. 2, shown operatively interfaced with respect to a cross-member.

FIG. 5 is a perspective, exploded view of a second embodiment of the torsion bar indexing attachment mechanism according to the present invention.

FIG. 6 is a perspective, operational view of the torsion bar indexing attachment mechanism of FIG. 5, shown operatively interfaced with respect to a cross-member.

### DESCRIPTION OF THE PREFERRED EMBODIMENT

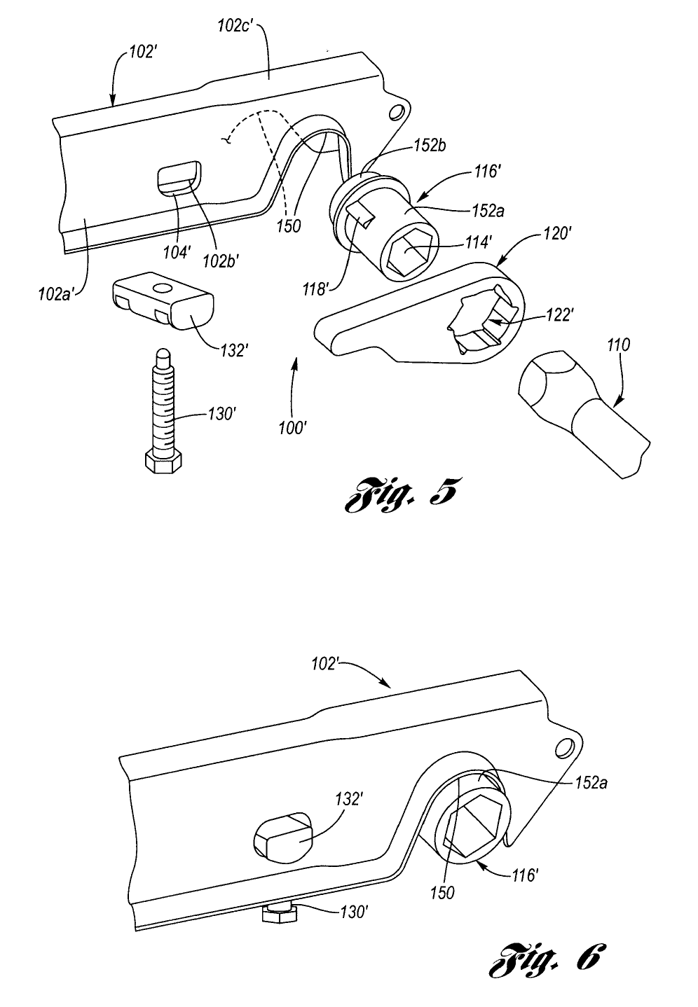

Referring now to the Drawing, FIGS. 2 through 6 depict examples of a torsion bar indexing attachment mechanism according to the present invention for attaching a range of different torsion bars to an adjustment arm which is, in turn according to a preferred example of operation which involves a motor vehicle torsion bar suspension, adjustably interfaced with a cross-member of a frame of a motor vehicle, wherein FIGS. 2 through 4 depict a first embodiment of the torsion bar indexing attachment mechanism 100, and FIGS. 5 and 6 depict a second embodiment of the torsion bar indexing attachment mechanism 100′. The motor vehicle torsion bar suspension may utilize the present invention with respect to either, or both, the front and rear set of wheels.

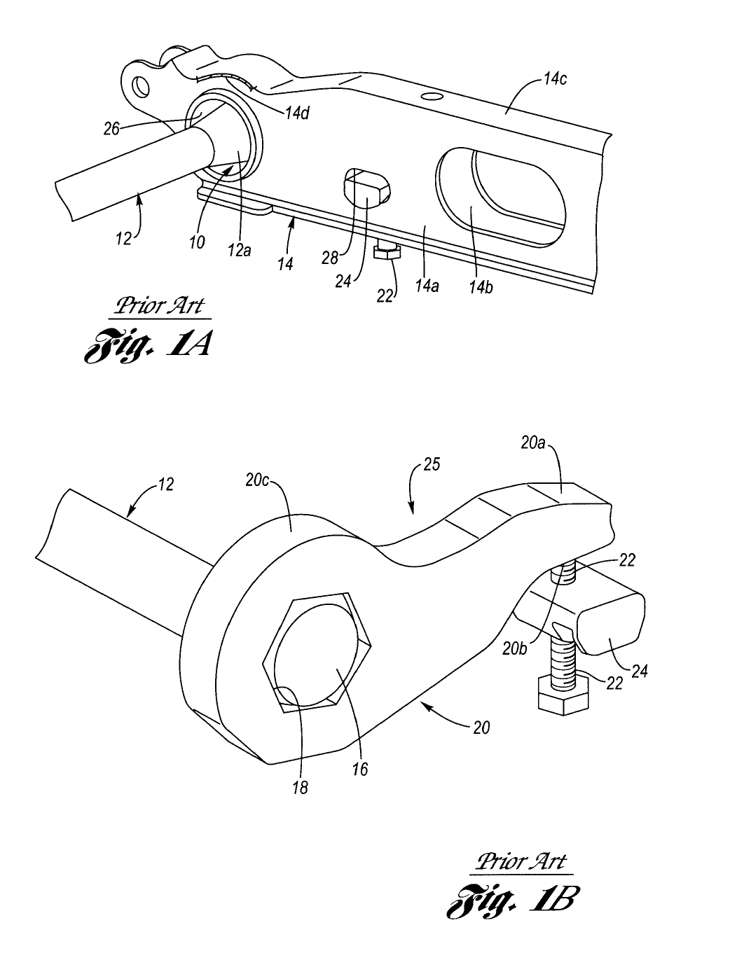

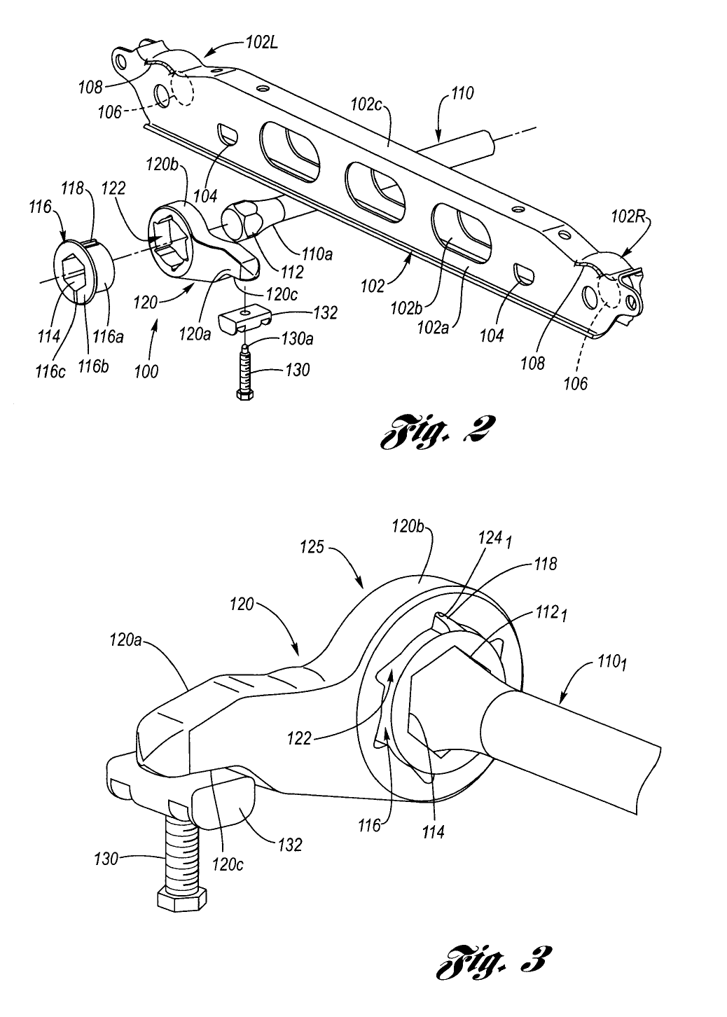

Turning attention to the first embodiment of the torsion bar indexing mechanism 100, FIGS. 2 and 4 depict a conventional cross-member 102 which is generally structurally similar to that described with respect to FIG. 1A. The cross-member 102 has a U-shape, defined by first and second sidewalls 102a, 102b which are both integrally connected, in normal relation, to an upper wall 102c. At each of the left and right end portions 102L, 102R, the first and second sidewalls 102a, 102b are: a non-circular adjuster nut hole 104; an aperture 106 in at least one of the first and second sidewalls (see FIG. 4); and the inner surface of the upper wall is provided with a concave surface contour 108 (see FIG. 2) which is disposed concentrically with respect to the aperture 106.

The end 110a of each torsion bar 110 of a range of torsion bars has a polygonal-faced head 112, a hexagon being shown by way of preferred example, and is the same as that used in the prior art as described with respect to FIGS. 1A and 1B. The torsion bar head 112 is received into a counterpart polygonal-faced head seat 114 (a hexagon being shown to compliment the hexagon-faced torsion bar head 112) of an adjuster barrel 116. The adjuster barrel 116 has at least one barrel tab 118 upstanding on its annular outer barrel surface 116a and preferably has an end flange 116b for providing seating guidance. Preferably, the outer barrel surface 116a is cylindrical and the end flange 116b is annular.

Each adjuster arm 120, there being an adjuster arm for each of the left and right end portions of the cross-member 102, has a barrel receptacle 122 formed therein for indexingly receiving thereinside the adjuster barrel 116, wherein a receptacle surface 122a is configured and sized to snugly abut the outer barrel surface 116a, preferably also cylindrical. The adjuster barrel 116 is indexingly disposed with respect to the adjuster arm by the barrel tab being received by a selected receptacle notch 124 formed in the receptacle surface 122a of the barrel seat 122, wherein n possible positions of the barrel receptacle are provided, each defined by a respective barrel notch, and each corresponding to use with a selected torsion bar.

With regard to indexing, a selected notch 124 is defined as a baseline angular datum. With respect to the datum, the angular separation, θ, of notches are governed by the following equation, for i=1 to n−1:

θ=(360/n)i+(α)i.

where theta, θ, is the position of the baseline notch (i.e., zero degrees), n is the number of indexable positions, and alpha, α, is a desired incremental angle (i.e., two degrees).

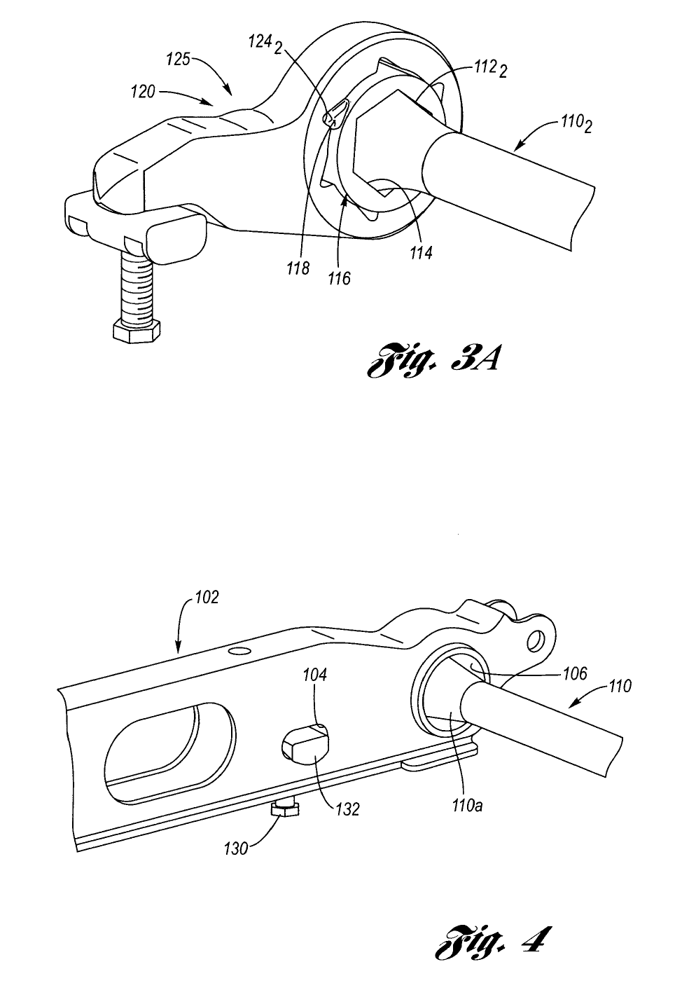

The result is the ability to align the barrel tab 118 with an appropriate receptacle notch 124, as is appropriate for a selected torsion bar of the range of torsion bars, of the n discrete angular positions. All values of n and α are contemplated by the present invention. For the construction shown in FIGS. 2 through 3B, n=6 and α=2 degrees.

By way of example, FIG. 3 shows a torsion bar head 112₁ of a first torsion bar 110₁ received in the head seat 114, wherein in proper installation with respect to the adjuster arm 120 a first receptacle notch 124, receives the barrel tab 118 of the adjuster barrel 116. Now, in the event the installation involved a second torsion bar 110₂ different from the first torsion bar 110₁, then with its head 112₂ seated in the head seat 114, a second receptacle notch 124₂ would receive the barrel tab 118, as illustrated at FIG. 3A.

An adjuster mechanism 125 is provided for adjusting the angular orientation of each adjuster arm, separately, with respect to the cross-member, is preferably similar to that of the prior art and described above with respect to FIG. 1B. The adjuster arm 120 has an arm member 120a and a convex contour surface 120b concentrically disposed with respect to the barrel receptacle 122. The arm member 120a has a land 120c adapted to abut the end 130a of an adjuster bolt 130. The adjuster bolt 130 is threadably engaged with a laterally elongated adjuster nut 132 which is seated in the adjuster nut hole 104.

In operation, the torsion bar head 112 is seated into the head seat 114 of the adjuster barrel 116, and the adjuster barrel, in turn, is seatably received into the barrel receptacle 122, wherein the barrel tab 118 is indexed to the particular, predetermined receptacle notch 124 which is appropriate for the selected torsion bar of the range of torsion bars. The torsion bar is then torsionally preloaded for the suspension system and particular torsion bar, and then adjusted to an appropriate torsional load by the adjuster mechanism 125, wherein the adjuster bolt is selectively rotated so that it threads with respect to the adjuster nut and thereby adjusts the angle of the adjuster arm 120 relative to the cross-member 102.

The loads applied upon the adjuster barrel 116 by torsional loads on the torsion bar 110 will cause the adjuster barrel to tend to rotate around the axis of the torsion bar. The barrel tab 118 of the adjuster barrel reacts against the receptacle notch 124 into which it is seated so as to thereby resist this tendency to rotate.

While compressive loading of an adjuster bolt is preferred, operation is not limited to this type of loading, as the torsion bolt can be rearranged with respect to the adjuster arm so as to be in extension, as opposed to compression.

As an optional construction for the adjuster barrel 116, the adjuster barrel may be provided with an axial slit 116c (see FIG. 2), wherein torsional loads of the torsion bar will cause the adjuster barrel to expand and thereby cause the outer barrel surface 116a apply a pressure to the receptacle surface 122a.

Turning attention now to FIGS. 5 and 6, a second embodiment of the torsion bar indexing attachment modality 100′ is depicted, wherein like parts to those described with respect to the first embodiment of the torsion bar indexing attachment mechanism 100 are identified by like numbers, and modified like parts are identified by like numbers with a prime, wherein the structural and operational aspects may be understood from the hereinabove description with respect to FIGS. 2 through 4.

Now the cross-member 102′ is modified so that each of the first and second sidewalls 102a′, 102b′ are provided with a bushing 150 at each of the left and right portions of the cross-member. The adjuster barrel 116′ is now provided at each end with a barrel arbor 152a, 152b. It will be understood from FIG. 6 that when assembled in the general sense of the description with respect to the first embodiment 100, the major difference is that the arbors 150a, 150b rotatably rest on the bushings 150, and there is an absence, or at least no need for, the concave contour surface of the cross-member abutting a convex contour surface of the adjuster arm, as was utilized in the first embodiment 100. Otherwise, operation of the first and second embodiments is essentially the same.

To those skilled in the art to which this invention appertains, the above-described preferred embodiment may be subject to change or modification. Such change or modification can be carried out without departing from the scope of the invention, which is intended to be limited only by the scope of the appended claims.

1. A torsion bar indexing attachment mechanism for attaching a polygonal-faced head of a torsion bar to a structure, comprising:
an adjuster arm comprising a barrel receptacle formed therein; a receptacle surface of said barrel receptacle; and a plurality of notches formed in said receptacle surface; and
an adjuster barrel comprising a polygonal-faced head seat formed therein configured for receiving the head of a torsion bar; an outer barrel surface; and a barrel tab formed on said outer barrel surface;
wherein the adjuster barrel is configured to be received in said barrel receptacle such that said barrel outer surface abuts said receptacle surface, and said barrel tab is received in a preselected notch of said plurality of notches which is appropriate for a preselected torsion bar when the head thereof is received in said head seat.

2. The indexing attachment mechanism of claim 1, wherein said barrel has an axial slit.

3. The indexing attachment mechanism of claim 1, further comprising:
a cross-member connected to the structure, said adjuster arm being in rotatable abutment with respect to said cross-member; and
an adjustment mechanism connected with said cross-member and interfaced with said adjuster arm, wherein selective adjustment of said adjuster mechanism thereby provides selective adjustment of orientation of said adjuster arm with respect to said cross-member.

4. The indexing attachment mechanism of claim 3, wherein said barrel has an axial slit.

5. The indexing attachment mechanism of claim 3, wherein said rotatable abutment of said adjuster arm with respect to said cross-member comprises:
a pair of bushings formed in said cross-member; and
a pair of arbors, one arbor respectively at each end of said adjuster barrel;
wherein each arbor abuts a respective bushing.

6. The indexing attachment mechanism of claim 5, wherein said barrel has an axial slit.

7. A torsion bar and torsion bar indexing attachment mechanism combination, comprising:
a range of torsion bars, each torsion bar of said range of torsion bars having a polygonal-faced head;
a cross-member connected to a frame; and
an indexing attachment mechanism attaching said polygonal-faced head to said cross-member, comprising:
an adjuster arm comprising a barrel receptacle formed therein; a receptacle surface of said barrel receptacle; and a plurality of notches formed in said receptacle surface; wherein said adjuster arm is disposed in rotatable abutment with respect to said cross-member; and
an adjuster barrel comprising a polygonal-faced head seat formed therein configured for receiving the head of said at least one torsion bar; an outer barrel surface; and a barrel tab formed on said outer barrel surface;
wherein the adjuster barrel is configured to be received in said barrel receptacle such that said barrel outer surface generally abuts said receptacle surface, and said barrel tab is received in a preselected notch of said plurality of notches, wherein said adjuster barrel thereby has an indexingly disposed position of a predetermined plurality of positions of the barrel receptacle, each said position being defined by a respective notch that corresponds to a particular torsion bar of said range of torsion bars.

8. The combination of claim 7, wherein said barrel has an axial slit.

9. The combination of claim 7, further comprising:
an adjustment mechanism connected with said cross-member and interfaced with said adjuster arm, wherein selective adjustment of said adjuster mechanism provides selective adjustment of orientation of said adjuster arm with respect to said cross-member.

10. The combination of claim 9, wherein said barrel has an axial slit.

11. The combination of claim 9, wherein said rotatable abutment of said adjuster arm with respect to said cross-member comprises:
a pair of bushings formed in said cross-member; and
a pair of arbors, one arbor respectively at each end of said receptacle barrel;
wherein each arbor abuts a respective bushing.

12. The combination of claim 11, wherein said barrel has an axial slit.
